(19) United States
(12) Patent Application Publication
(10) Pub. No.: US 2007/0186454 A1
(43) Pub. Date: Aug. 16, 2007

(54) Winding advertisement curtain on an electric winging door

(76) Inventors: Wen-Cheng Yang, Yilan City (TW); Hsiao-Yen Chou, Taipei City (TW); Chien-Chang Chiu, Taoyuan City (TW)

Correspondence Address: BRUCE H. TROXELLL, SUITE 1404, 5205 LEESBURG PIKE, FALLS CHURCH, VA, 22041, US

(21) Appl. No.: 11/354,849

(22) Filed: Feb. 16, 2006

(51) Int. Cl. G09F 11/18

(52) U.S. Cl. 40/514

(57) ABSTRACT

A winding advertisement curtain on an electric winding door includes a winding unit and a cloth curtain, and the winding unit consists of an upper case, a winding shaft and a spring. The upper case is fixed on an outer surface of an upper case of an electric winding door, and the winding shaft is arranged in the upper case, possible to be counter-rotated by the spring. The cloth curtain, which has advertising patterns or words on its outer surface, has its upper end connected to the winding shaft and possible to be wound around it, and its lower end temporarily attached by sucking the lower end of the slats of the winding door. So the cloth curtain is possible to be pulled down or wound up automatically together with the slats of the winding door, and then the advertising patterns or words become visible when the cloth curtain is closed down, achieving advertising effect.

### BACKGROUND OF THE INVENTION

1. Field of the Invention

This invention relates to an electric winding door, particularly to one added with a winding advertisement curtain for propagating advertisement for something.

2. Description of the Prior Art

Nowadays various kinds of advertisement boards are used by stores along busy streets, especially during business time, for drawing attentions of passersby. Among them, many electric winding doors of stores may be coated with advertising patterns or words to achieve advertising effect during the closed time.

However, the conventional ways of coating advertisement patterns or words are not so ideal, because the drawn or painted patterns or words may be gradually peeled off by wining up and down the electric winging door. Further, if the old painted patterns or words are to be replaced with new patterns or words, they have to be erased off and painted anew with new patterns or words, troublesome to work it out. Moreover, an electric winding door has an uneven surface so the drawn or painted patterns or words may not be seen quite clear. Or in case an advertisement printed on a paper is adhered on an electric winding door, its replacement is also not simple, with an old one being removed first and at the same time, its effect is reduced a lot owing to the rough surface of an electric winding door. In addition, the adhered advertisement paper may be bruised or damaged by winding-up-and-down movement of the electric winding door.

### SUMMARY OF THE INVENTION

The feature of the invention is a winding unit for winding up a cloth curtain with an advertising patterns or words printed or pained on its outer surface. The winding unit consists of an upper case and a winding shaft arranged in the upper case for winding up the cloth curtain or pulled down with the resilience of a spring, together with the winding door electrically wound up or pulled down. The upper case of the winding unit is fixed on an outer surface of an upper case of an electric advertisement door, and the lower end of the cloth curtain is fixed temporarily with the lower end of the slats of the winding door. So the cloth curtain can be wound up by the resilience of the spring compressed synchronously together with the winding door wound up electrically, or pulled down together with the winding door pulled down electrically. So the advertising patterns or words on the cloth curtain is visible in case the cloth curtain is pulled down together with the winding door closed down, achieving the advertising effect. In addition, the cloth curtain is hidden in the upper case when not in use, never damaged or damaging the color or the patterns on the outer surface of the winding door.

### BRIEF DESCRIPTION OF DRAWINGS

This invention will be better understood by referring to the accompanying drawings, wherein:

FIG. 1 is a perspective view of a first embodiment of a winding advertisement curtain on an electric winding door in a closed condition in the present invention;

FIG. 2 is an exploded perspective view of the first embodiment of a winding advertisement curtain on an electric winding door in the closed condition in the present invention;

FIG. 3 is a side cross-sectional view of the first embodiment of a winding advertisement curtain on an electric winding door in the closed condition in the present invention;

FIG. 4 is a partial exploded perspective view of the first embodiment of a winding advertisement curtain on an electric winding door in the present invention;

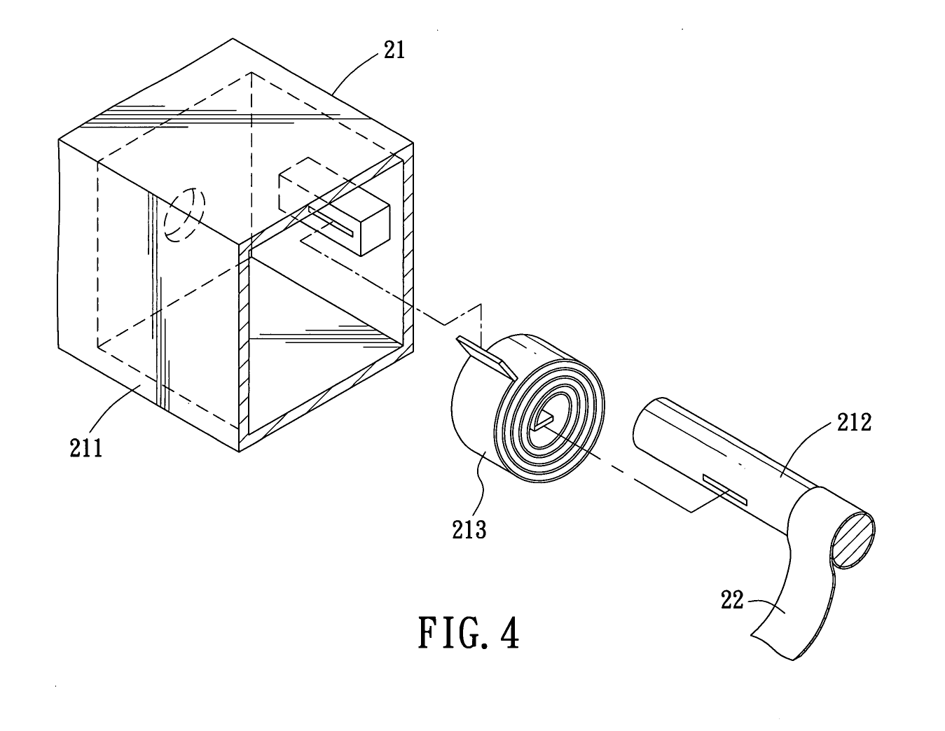

FIG. 5 is a side cross-sectional view of the first embodiment of a winding advertisement curtain on an electric winding door in the present invention, showing it being wound up;

FIG. 6 is a side cross-sectional view of the second embodiment of a winding advertisement curtain on an electric winding door in the present invention, showing it completely wound up in an opened condition; and,

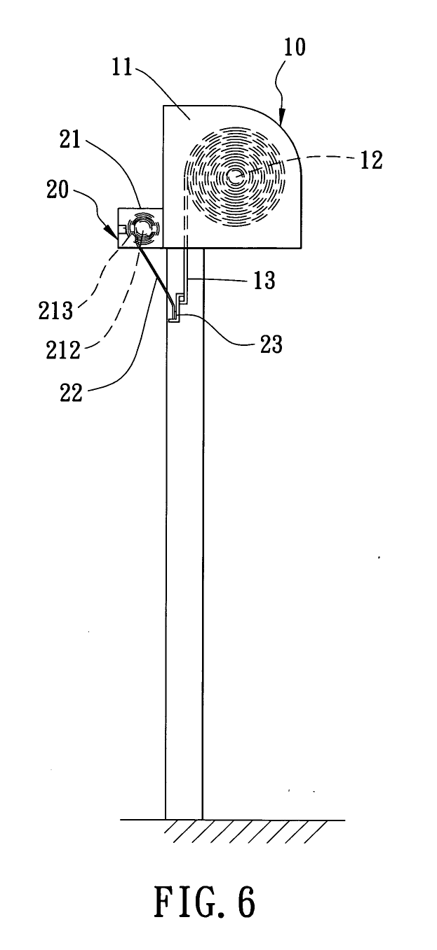

FIG. 7 is an exploded perspective view of a second embodiment of a winding advertisement curtain on an electric winding door in the present invention.

### DETAILED DESCRIPTION OF THE PREFERRED EMBODIMENTS

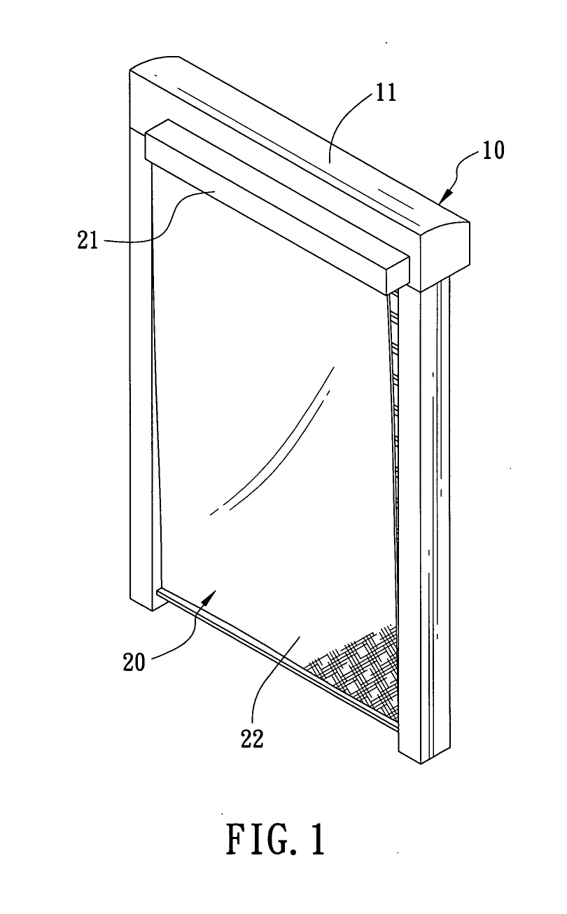

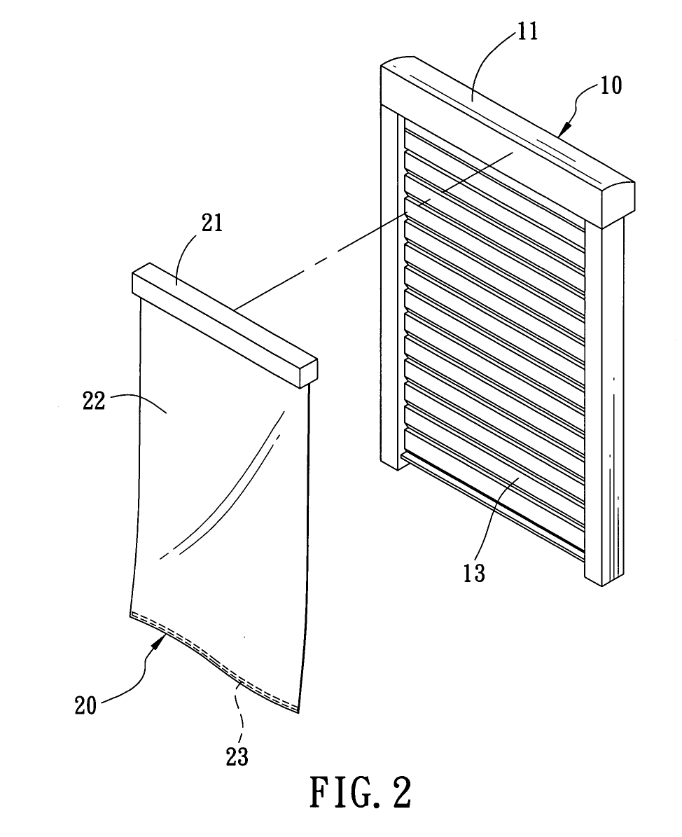

A first preferred embodiment of a winding advertisement curtain 20 on an electric winding door in the present invention, as shown in FIGS. 1, 2 and 3, is combined with an electric winding door 10.

The electric winding door 10 has almost the same structure of a conventional one, composed of an upper case 11, a wind shaft 12 arranged in the upper case 11, and an electric motor (not shown) driving the wind shaft 12 to rotate clockwise and counterclockwise, a plurality of slats 13 connected continually with each other and then possible to be wound around the wind shaft 12 to open the winding door 10.

The winding advertisement curtain 20 is composed of a winding unit 21, a cloth curtain 22 and a position member 23.

The winding unit 21 consists of an upper case 211, a winding shaft 212 and a coiled spring 213, fixed on an outer surface of the upper case 11 of the electric winding door 10, with the winding shaft 212 contained in the upper case 211, and with the coiled spring 213 fitted around the winding shaft 212 and having its inner end fixed with the winding shaft 212 and positioned between the winding shaft 212 and the upper case 211. When the winding shaft 212 is rotated in a preset direction, the coiled spring 213 may be rotated at the same time to become tighter and tighter to cause some resilience to counter-rotate the winding shaft 212 if the winding shaft is no longer pulled.

The cloth curtain 22 has a proper size to hide the electric winding door 10, printed with, coated with or painted with an advertising pattern or words on its outer surface, having its upper end fixed tightly on the winding shaft 212 and a horizontal position member 23 such as a magnetic rod or the like for sucking the bottom end of the slats 13 made of steel.

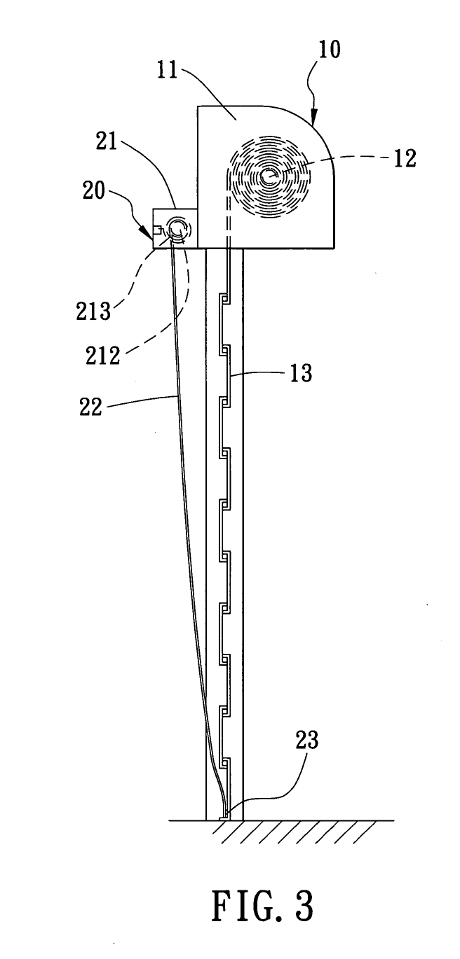

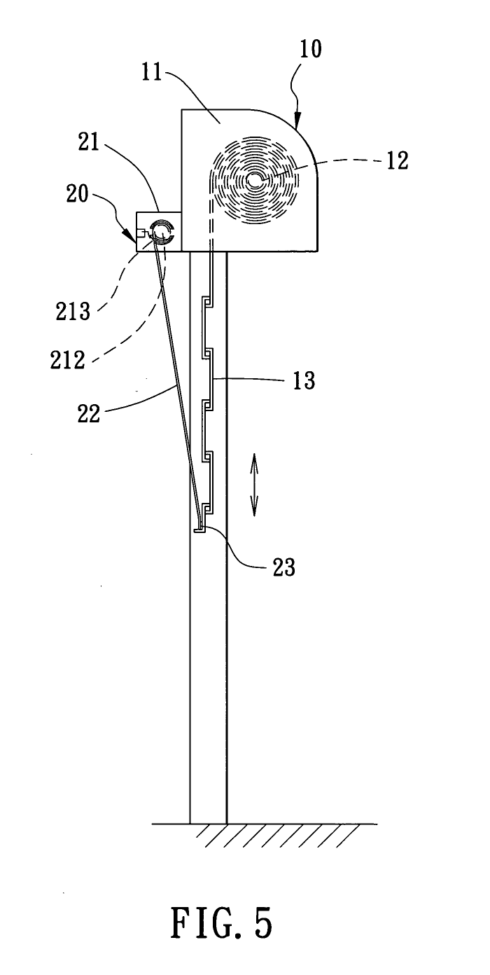

As to the use of the winding advertisement curtain 20, as shown in FIGS. 3 and 5, it can be applied to an electric winding door 10, with its bottom end of the cloth curtain 22 sucking the lower end of the slats 13 of the electric winding door 10. So during the resting time of a store or a living house, the electric winding door 10 can be wounded down to close, with the winding advertisement curtain 22 wound down together with the winding door 10 at the same time, with the advertising pattern or words on the outer surface of the cloth curtain 22 visible for passersby to achieve an advertising effect for the area of the electric winding door 10.

On the contrary, when the winding door 10 is electrically wound up to open, the closed-down cloth curtain 22 is also wound up around the winding shaft 212 by the resilience of the coiled spring 213 and at the same time synchronously together with the winding door 10 pulled up electrically.

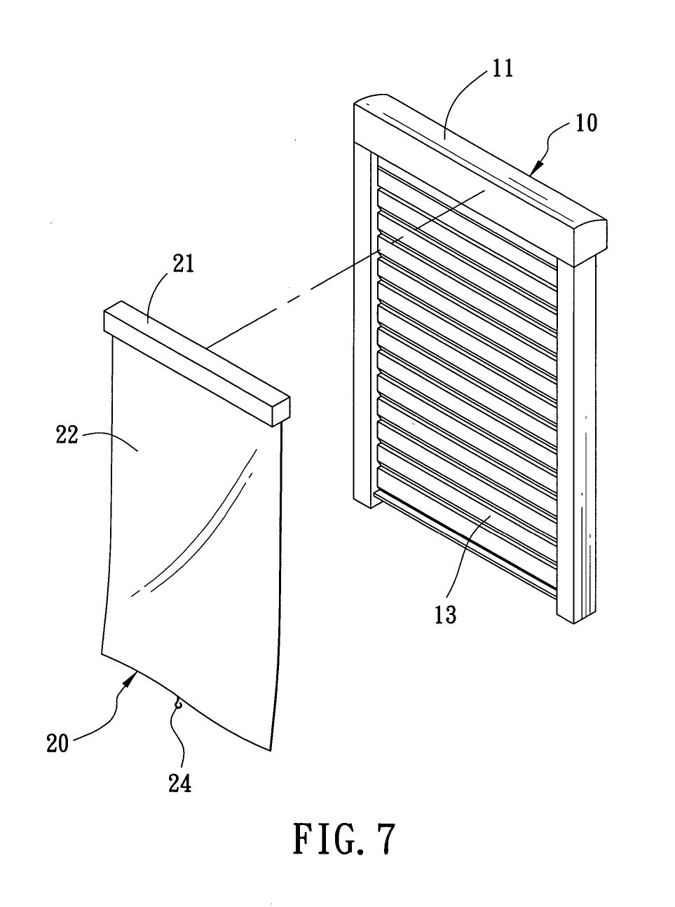

Further, FIG. 7 shows a second embodiment of a winding advertisement curtain 20, which has a difference from the first embodiment in that a position hook 24 is used instead of the magnetic position member 23 for hooking with the lower end of the winding door 10 to keep the closed-down cloth curtain 22 stably not to be pulled up.

The invention has the following advantages, as can be understood from the foresaid description.
1. The cloth curtain 22 can be automatically closed down or opened up together with the winding door 10, so long as the magnetic position member 23 or the hook 24 is attached with the lower end of the winding door 10.
2. The cloth curtain 22 is very flat, having almost the same area as that of the winding door 10, possible to give vivid impression to passersby, achieving good advertising effect.
3. The cloth curtain 22 never damages the color or pattern on the winding door 10, and the old cloth curtain 22 may be easily replaced with a new one, very convenient.
4. The cloth curtain 22 can be wound around the winding shaft 212 in the upper case 211, safely kept hidden and not to be damaged easily, having a long service life.
5. The upper case 211 and the cloth curtain 22 of the advertisement curtain 20 are collapsible relative to the electric winding door 10, easy to assemble or disassemble for a user, and possible to be used repeatedly.

While the preferred embodiments of the invention have been described above, it will be better understood that various modifications may be made therein and the appended claims are intended to cover all such modifications that may fall within the spirit and scope of the invention.

What is claimed is:

1. A winding advertisement curtain on an electric winding door, said winding advertisement curtain installed between an upper case and a lower end of slats of said winding door, said winding advertisement curtain comprising:
a winding unit consisting of an upper case fixed on an outer surface of said upper case of said winding door, a winding shaft arranged in said upper case of said winding unit, and a spring fitting around said winding shaft for elastically counter-rotating said winding shaft;
a cloth curtain having a proper size and advertising patterns or word printed or painted on its outer surface, an upper end of said cloth curtain connected with said winding shaft, said cloth curtain having its lower end fixed with a position member to be attached with a lower end of said slats of said winding door, said cloth curtain pulled down synchronously with said slats when said slats are pulled down for closing, said patterns or words on the outer surface of said cloth curtain extended and becoming visible at the front of said slats of said winding door, said cloth curtain possible to be wound up at the same time with said winding door when said slats pulled up and wound around a winding shaft in said upper case of said electric winding door.

2. The winding advertisement curtain as claimed in claim 1, wherein said spring in said winding advertisement curtain is a coiled spring.

3. The winding advertisement curtain as claimed in claim 2, wherein said coiled spring has one end connected to said upper case of said winding unit and the other end connected to said winding shaft, so said winding shaft can be counter-rotated by the resiliency of said coiled spring after said winding shaft is rotated in a preset direction.

4. The winding advertisement curtain as claimed in claim 1, wherein said position member of said winding advertisement curtain is a magnetic stuff, possible to suck the lower end of said slats of said winding door.

5. The winding advertisement curtain as claimed in claim 1, wherein said position member is a hook to hook with the lower end of said slats.
